(19) United States
(12) Patent Application Publication
(10) Pub. No.: US 2005/0018383 A1
(43) Pub. Date: Jan. 27, 2005

(54) Electrolyte solution for electrolytic capacitors electrolytic capacitor comprising said electrolyte solution and the use thereof

(76) Inventor: Thomas Ebel, Milano (IT)

Correspondence Address: FISH & RICHARDSON PC, 225 FRANKLIN ST, BOSTON, MA, 02110, US

(21) Appl. No.: 10/488,154

(22) PCT Filed: Aug. 8, 2002
(86) PCT No.: PCT/DE02/02930

(30) Foreign Application Priority Data
Aug. 30, 2001 (DE) 101 42 100.1

(51) Int. Cl. H01G 9/00

(52) U.S. Cl. 361/503

(57) ABSTRACT

The invention relates to an electrolyte solution for electrolytic capacitors, in which cyclic, unsymmetrical dicarboxylic acids are used as support!electrolytes. The inventive electrolytes are characterized by an increased conductivity with an improved sparking voltage as a result of the unsymmetrical structure of the cyclic dicarboxylic acids. The invention also relates to an aluminum electrolytic capacitor containing the inventive operational electrolyte.

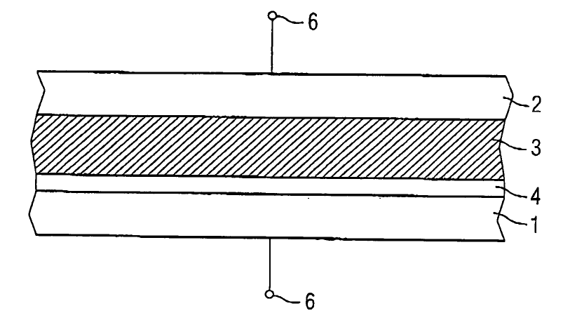

Aluminum electrolytic capacitors are constructed as an arrangement of, for example, a cathode aluminum foil and an anode foil which is composed of aluminum and which has an oxide layer which acts as a dielectric and which has been applied to the foil directly by electrochemical processes. A single- or multi-ply layer is interleaved between the foils and is composed for example of paper and is impregnated with the electrolyte solution. The arrangement customarily takes the form of a coil which is wound on a mandrel and is installed in an aluminum cup.

Electrolyte solutions of electrolytic capacitors generally comprise a conducting salt based on long-chain aliphatic dicarboxylic acids and also a solvent, for example ethylene glycol. An example of a conducting salt used is dodecanedioic acid, which is generally used in the form of ammonium salts.

This straight-chain aliphatic dicarboxylic acid has the disadvantage, however, that it can for example react with the solvent, especially alcohols, or the ammonium ions, so that esterifications or amide formations can occur. These reactions result in a decrease in the fraction of dissociated conducting salt in the electrolyte solution and hence in the conductivity of the electrolyte solution during operation of the capacitor, especially at comparatively high temperatures.

Electrolyte solutions for use of capacitors at high voltages shall combine high conductivity with maximum spark voltage resistance. Conventional electrolyte solutions utilizing dodecanedioic acid and ethylene glycol as solvent have an approximate conductivity of about 1.9 mS/cm coupled with a spark voltage of 430 V.

It is an object of the present invention to provide an electrolyte solution which makes it possible to produce electrolytic capacitors which have higher conductivity and improved spark voltage characteristics than conventional capacitors while at the same time avoiding the aforementioned disadvantages of conventional electrolyte solutions.

This object is achieved according to the invention by an electrolyte solution according to claim 1. Further advantageous embodiments of the electrolyte solution and also an electrolytic capacitor comprising the inventive electrolyte solution and the use of the capacitor for high voltages form part of the subject matter of further claims.

An inventive electrolyte solution consists of a component A), which includes at least one conducting salt which comprises the salt of a cyclic asymmetrical dicarboxylic acid, and contains a solvent as a component B).

Compared with prior art electrolyte solutions, which utilize long-chain aliphatic dicarboxylic acids or their salts as conducting salts, the inventive electrolyte solution has the advantage that cyclic dicarboxylic acids have a relatively rigid molecular skeleton by virtue of ring formation. Long-chain, non-rigid molecules may disadvantageously exist in a multiplicity of conformations which moderate the symmetry-breaking properties of substituents. Asymmetrical dicarboxylic acids are generally more soluble than symmetrical dicarboxylic acids, resulting in an electrolyte solution having higher conductivity.

The rigidity of the basic skeletons of cyclic dicarboxylic acids provides a particularly advantageous way (either by introducing substituents or because a basic skeleton is already asymmetrical) to obtain asymmetrical dicarboxylic acids, which results in electrolyte solutions having higher conductivity. Cyclic asymmetrical dicarboxylic acids frequently have higher dipole moments and hence higher polarity than aliphatic long-chain carboxylic acids having the same number of carbon atoms. Asymmetrical dicarboxylic acids for the purposes of this invention are non-symmetrical dicarboxylic acids which, aside from the identity E, have no further symmetry element. For this, the chapter “Die Symmetrie: Beschreibung und Anwendung” in P. W. Atkins: “Physikalische Chemie”, VCH-Verlagsgesellschaft Weinheim, 1990, 2^{nd} corrected reprint of 1^{st} edition, is incorporated herein in its entirety by reference.

The relatively rigid basic skeletons of cyclic asymmetrical dicarboxylic acids also shield the carboxylate groups from possible reaction partners, such as alcohols or amines for example, by virtue of sterical effects. This is why the previously mentioned esterification reaction or amide formation is greatly retarded with inventive cyclic asymmetrical dicarboxylic acids, so that inventive electrolytes are superior to conventional electrolytes in having a better long-term stability coupled with unchanged conductivity.

Good capacitor spark voltage characteristics also require that the dielectric oxide layer, the forming layer, on the electrodes remain intact during capacitor operation. This makes it necessary to use conducting salts which are large, long-chain weak organic acids which cannot be incorporated in the oxide layer during capacitor operation and, what is more, possess formability, i.e., augment the buildup of the oxide layer during capacitor operation, so that oxide layer breakdown and hence a spark strike can be prevented.

Since cyclic asymmetrical dicarboxylic acids are also weak organic acids having large basic skeletons, they are simultaneously able to regenerate (i.e., form) the dielectric oxide layer on the electrodes of the capacitor during capacitor operation.

Salts of cyclic asymmetrical dicarboxylic acids are generally preparable by reacting the free dicarboxylic acid with a base, for example ammonia or amines, to form the salt. The solvent has a dissociating effect on the salts of cyclic dicarboxylic acids.

It is advantageous to use mono-, di-, tri- or polycyclic asymmetrical carboxylic acids, skeleton rigidity increasing as the number of cyclic carbon rings increases. It is possible to use mixtures of various cyclic asymmetrical dicarboxylic acids for the inventive electrolyte solutions.

Component A) is advantageously selected from a group of monocyclic dicarboxylic acids of the following general formula except symmetrical dicarboxylic acids: 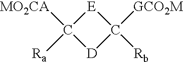
where E and D are identical or different from each other and are selected from a group (CR¹⁰R¹¹)ₙ where 0≦n≦4 subject to the proviso that the sum total of the two n indices is not equal to 0 and n is an integer, wherein R¹⁰ and R¹¹ are identical or different from each other and are selected from a set which contains the following substituents:
a) one hydrogen,
b) one alkyl group of 1 to 12 carbon atoms which is optionally branched,
c) one aryl group of 5 to 12 carbon atoms which is optionally substituted and wherein one or more carbon atoms may be replaced by nitrogen, sulfur and/or oxygen,
d) one alkoxy group of 1 to 12 carbon atoms,
   where A and G are identical or different from each other and are selected from the group (CR¹²R¹³)ₘ where 0≦m≦10, wherein m is an integer, wherein R¹² and R¹³ are identical or different from each other and are selected from a set which contains the following groups or atoms:
a) hydrogen ion,
b) one alkyl group of 1 to 12 carbon atoms which is optionally branched,
c) one aryl group of 5 to 12 carbon atoms which is optionally substituted and wherein one or more carbon atoms may be replaced by nitrogen, sulfur and/or oxygen,
d) one alkoxy group of 1 to 12 carbon atoms,
   where Rₐ and R_{b} are identical or different from each other and are selected from a set which contains the following substituents:
a) one alkyl group of 1 to 12 carbon atoms which is optionally branched,
b) one aryl group of 5 to 12 carbon atoms which is optionally substituted and wherein one or more carbon atoms may be replaced by nitrogen, sulfur and/or oxygen,
c) one alkoxy group of 1 to 12 carbon atoms,
   where M is selected from a set of the following counterions:
a) hydrogen ion,
b) ammonium ions, NH4⁺ and/or organic alkyl-substituted ammonium ions.

Preferably, these compounds are dicarboxylic acids which contain at least one of the following dicarboxylic acids except symmetrical dicarboxylic acids:
a) dicarboxylic acids of the general formula 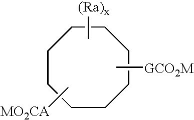
   where 0≦x≦7
   and x is an integer
b) dicarboxylic acids having the following general formula 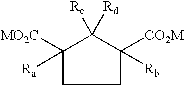
   where M, A, G, Rₐ and R_{b} are each as defined above and R_{c} and R_{d} are selected from the set already mentioned for Rₐ and R_{b}.

Compounds used in particular are camphoric acid and cyclooctadienedicarboxylic acid and also salts thereof. Cyclooctadienedicarboxylic acid as used herein is to be understood as meaning tetrahydrocyclooctadiene-dicarboxylic acid and its salts.

Useful polycyclic dicarboxylic acids include for example dicarboxylic acids having the following general formulae except symmetrical dicarboxylic acids:
a) of the following formula 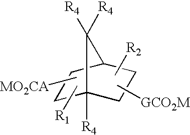
   and/or
b) dicarboxylic acids of the following formula 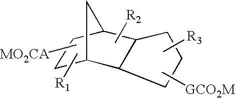
   where in each of which formulae A and G are identical or different from each other and are a bivalent group (CR¹²R¹³)ₘ where 0≦m≦10, m being an integer, wherein R¹² and R¹³ are identical or different from each other and are selected from the set which contains the following substituents or atoms:
a) hydrogen,
b) one alkyl group of 1 to 12 carbon atoms which is optionally branched,
c) one aryl group of 5 to 12 carbon atoms which is optionally substituted and wherein one or more carbon atoms may be replaced by nitrogen, sulfur and/or oxygen,
d) one alkoxy group of 1 to 12 carbon atoms,
   wherein in both formulae R₁, R₂, R₃ and R₄ are identical or different from each other and are selected from a set which contains the following substituents:
a) hydrogen,
b) one alkyl group of 1 to 12 carbon atoms which is optionally branched,
c) one aryl group of 5 to 12 carbon atoms which is optionally substituted and wherein one or more carbon atoms may be replaced by nitrogen, sulfur and/or oxygen,
d) one alkoxy group of 1 to 12 carbon atoms, and
   M in either formulae is selected from the set of the following counterions:
a) hydrogen ion,
b) quaternary ammonium ions, NH4⁺ and/or organic alkyl-substituted ammonium ions.

The formula shown last concerns derivatives of dicyclopentanedicarboxylic acid. Dicyclopentane-dicarboxylic acid as used herein is to be understood as meaning tetrahydrodicyclopentanedicarboxylic acid and its salts as per the following general formula: 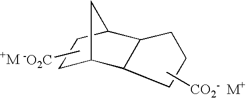
where M⁺ is selected from the set of the following counterions:
a) hydrogen cation
b) quaternary ammonium ions, NH4⁺ and/or organic alkyl-substituted ammonium ions.

The particularly pronounced asymmetry of the molecular skeleton in this case results in a particularly high solubility for these salts in the solvents and hence a particularly high conductivity coupled with good spark voltage resistance. The synthesis is such that, the position of the two carboxylate groups in the cyclic base structure varies, so that inventive electrolyte solutions may also comprise mixtures of various isomers of dicyclopentanedicarboxylic acid.

Component B) is advantageously a dihydric alcohol, for example ethylene glycol, diethylene glycol or propylene glycol. It is also possible to use mixtures of various alcohols. It is further possible to use cyclic esters, for example gamma-butyrolactone, as a solvent.

Boric acid derivatives, for example ammonium pentaborate, may advantageously be used as an additional component C). Ammonium pentaborate serves in particular as a forming salt to preserve the dielectric oxide layer on the electrodes of the capacitor, but also acts as a conducting salt, since it dissociates in solvents. A further possible constituent of component C) is mannitol, which has a corrosion-inhibiting effect and also brings about an additional further increase in the spark voltage.

The inventive cyclic dicarboxylic acids as component A) are generally used to comprise from 1% to 15% by weight of the electrolyte solution, a range from 3% to 8% by weight being preferred. The borates are generally used to comprise from 2% to 20% by weight of the electrolyte solution.

The inventive electrolyte solution will now be more particularly described with reference to an illustrative embodiment and a figure of an electrolytic capacitor comprising the inventive electrolyte solution.

The table which follows compares an inventive electrolyte solution based on diammonium dicyclopentanedioate, the diammonium salt of tetrahydrodicyclopentanedicarboxylic acid, (Example 1) with a conventional electrolyte solution containing diammonium dodecanoate as a conducting salt (Example 2) in terms of their composition and their characteristic electrical data, conductivity and spark voltage.

| | Example 1 | Example 2 |
|---|---|---|
| Ethylene glycol | 89 | 89 |
| [% by weight] | | |
| Diammonium dodecanoate | — | 5 |
| [% by weight] | | |
| Diammonium dicyclo- | 5 | — |
| pentanedioate | | |
| [% by weight] | | |
| Ammonium pentaborate | 4 | 4 |
| [% by weight] | | |
| Mannitol | 2 | 2 |
| [% by weight] | | |
| Conductivity | 2.0 | 1.9 |
| [mS/cm] | | |
| Spark voltage | 445 | 430 |
| [V] | | |

The table shows that using diammonium dicyclopentane-dioate instead of diammonium dodecanoate is a way to achieve improved conductivity coupled with increased spark voltage. Long-term tests showed at the same time that the inventive electrolyte solution comprising diammonium dicyclopentanedioate stays formable, and hence is able to preserve the dielectric oxide layer, when operated for more than 2000 hours.

The figure shows by way of example a coil of an aluminum electrolytic capacitor in a schematic cross section.

The coil of the electrolytic capacitor consists of an anode layer 1 whose upper surface supports an anode oxide layer 4. The anode layer 1 is an aluminum foil about 50 to 120 μm in thickness. The anode oxide layer 4 consists of aluminum oxide and is between 5 and 1000 nm in thickness.

The anode oxide layer 4 has a separating layer disposed thereabove. The separating layer 3 is between 30 and 200 μm in thickness and preferably consists of paper. A cathode layer 2 is disposed above the separating layer 3. The separating layer 3 is saturated with the operating electrolyte of this invention. The anode layer 1 and cathode layer 2 are each electroconductingly connected to a capacitor terminal 6. The capacitor coil is customarily installed in an aluminum cup.

Electrolytic capacitors containing electrolyte solutions of this invention are useful for high-voltage ranges having nominal voltages between 350 and 600 volts.

1. An electrolyte solution for capacitors which comprises:
component A) at least one salt of a cyclic asymmetrical dicarboxylic acid, and component B) at least one solvent.

2. The electrolyte solution according to claim 1, wherein said component A) is selected from a set which contains mono-, di-, tri- and poly-cyclic asymmetrical dicarboxylic acids.

3. The electrolyte solution according to claim 1, wherein said component A) is selected from a group of monocyclic dicarboxylic acids of the following general formula provided that symmetrical dicarboxylic acids are excluded: 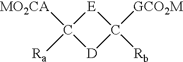
in which
E and D are identical or different from each other and are selected from a bivalent group (CR¹⁰R¹¹)ₙ in which 0≦n≦4 subject to the proviso that the sum total of the n in the D and the n in the E is not equal to 0, and R¹⁰ and R¹¹ are identical or different from each other and are selected from a group which contains the following substituents or atoms:
a) one hydrogen,
b) one alkyl group of 1 to 12 carbon atoms which is optionally branched,
c) one aryl group of 5 to 12 carbon atoms which is optionally substituted and in which one or more carbon atoms may be replaced by nitrogen, sulfur and/or oxygen, and
d) one alkoxy group of 1 to 12 carbon atoms;
A and G are identical or different from each other and are selected from a set of the bivalent group (CR¹²R¹³)ₙ in which 0≦m≦10, and R¹² and R¹³ are identical or different from each other and are selected from a set which contains the following groups:
a) hydrogen,
b) one alkyl group of 1 to 12 carbon atoms which is optionally branched,
c) one aryl group of 5 to 12 carbon atoms which is optionally substituted and in which one or more carbon atoms may be replaced by nitrogen, sulfur and/or oxygen, and
d) one alkoxy group of 1 to 12 carbon atoms;
Rₐ and R_{b} are identical or different from each other and are selected from a set which contains the following substituents:
a) one alkyl group of 1 to 12 carbon atoms which is optionally branched,
b) one aryl group of 5 to 12 carbon atoms which is optionally substituted and in which one or more carbon atoms may be replaced by nitrogen, sulfur and/or oxygen, and
c) one alkoxy group of 1 to 12 carbon atoms, and
M is selected from a set of the following counterions:
a) hydrogen ion, and
b) ammonium ions, NH₄⁺ and/or organic alkyl-substituted ammonium ions.

4. The electrolyte solution according to claim 1, wherein said component A) contains a salt of at least one of the following cyclic dicarboxylic acids provided that symmetrical dicarboxylic acids are excluded,
a) dicarboxylic acids of the general formula I 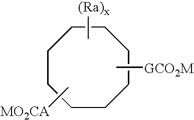
in which 0≦x≦7; and
b) dicarboxylic acids having the following general formula II 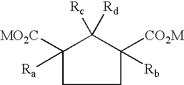
in which M, A, G, Rₐ and R_{b} are each as defined above and R_{c} and R_{d} are selected from the set already mentioned for Rₐ and R_{b}.

5. The electrolyte solution according to claim 1, wherein said component A) comprises at least one of camphoric acid and cyclooctadienendicarboxylic acid.

6. The electrolyte solution according to claim 1, wherein said component A) contains a salt of at least one of the following polycyclic dicarboxylic acids subject to the proviso that symmetrical dicarboxylic acids are excluded:
a) dicarboxylic acids of the following formula 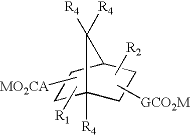
b) dicarboxylic acids of the following formula 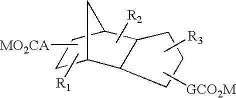
in which:
A and G are identical or different from each other and are a bivalent group (CR¹²R¹³)ₘ in which 0≦m≦10, and R¹² and R¹³ are identical or different from each other and are selected from a set which contains the following substituents:
a) hydrogen,
b) one alkyl group of 1 to 12 carbon atoms which is optionally branched,
c) one aryl group of 5 to 12 carbon atoms which is optionally substituted and in which one or more carbon atoms may be replaced by nitrogen, sulfur and/or oxygen, and
d) or one alkoxy group of 1 to 12 carbon atoms;
R₁, R₂, R₃ and R₄ are identical or different from each other and are selected from a set which contains the following groups:
a) hydrogen,
b) one alkyl group of 1 to 12 carbon atoms which is optionally branched,
c) one aryl group of 5 to 12 carbon atoms which is optionally substituted and in which one or more carbon atoms may be replaced by nitrogen, sulfur and/or oxygen, and
d) or one alkoxy group of 1 to 12 carbon atoms, and
M is selected from the set of the following counterions
a) hydrogen ion, and
b) quaternary ammonium ions, NH ₄⁺ and/or organic alkyl-substituted ammonium ions.

7. The electrolyte solution according to claim 1, wherein said component B) comprises dihydric alcohols or cyclic esters.

8. The electrolyte solution according to claim 7, wherein said component B) comprises ethylene glycol, propylene glycol or gamma-butyrolactone.

9. The electrolyte solution according t0 claim 1 further comprising component C), wherein said component C) comprise ammonium pentaborate.

10. The electrolyte solution according to the claim 9, wherein said component C) further comprises mannitol.

11. The electrolyte solution according to claim 1, wherein the electrolyte solution comprises 1% to 15% by weight said component A).

12. The electrolyte solution according to claim 11, wherein the electrolyte solution said component A).

13. The electrolyte solution according to claim 10,
wherein said component A) comprises diammonium dicyclopentanedioate,
said component B) comprises ethylene glycol, and
said component C) comprises ammonium pentaborate and mannitol.

14. The electrolytic capacitor having an electrolyte solution according to claim 1 comprising a coil having an anode layer and a cathode layer and also an interleaved separating layer which is saturated with said electrolyte solution, wherein said anode layer has an oxide layer on the side which faces said separating layer.

15. The use of an electrolytic capacitor according to claim 14 for a voltage range having nominal voltages between 350 and 600 volts.
